(19) United States
(12) Patent Application Publication
(10) Pub. No.: US 2021/0178862 A1
(43) Pub. Date: Jun. 17, 2021

(54) VENT MOUNT WITH FRAGRANCE CARTRIDGE HOLDER

(71) Applicant: Scosche Industries, Inc., Oxnard, CA (US)

(72) Inventors: Kasidy Alves, Oxnard, CA (US); Yasuhiro Yamamoto, Thousand Oaks, CA (US)

(21) Appl. No.: 16/717,244

(22) Filed: Dec. 17, 2019

(51) Int. Cl. B60H 3/00

(52) U.S. Cl. CPC B60H 3/0028

(57) ABSTRACT

A vent mount has a housing that defines an open top slot and an interior cavity receptive to a fragrance cartridge through the open top slot. A first rotatable joint element has an extension stalk centrally fixed to the housing. A magnetic device mount head has a second rotatable joint element coupled to the first rotatable joint element. The vent mount has a vent grill clamp centrally fixed to and extends from the fragrance cartridge housing.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to mounts for securing mobile devices to a structure, and more particularly, to a vent-attached mobile device mount accepting air freshener fragrance cartridges.

### 2. Related Art

A wide variety of portable electronic devices are currently in existence on the market, though there has been a recent convergence towards a fewer category of devices that fulfill many needs. Typically, these are smartphones that which integrate functions and features that may have earlier been provided in separate, independent devices such as music players, gaming consoles, personal digital assistants, digital still and video cameras, electronic readers, mapping and navigation devices, and so on. Several short-to-medium range communications modalities are also integrated, including WiFi and Bluetooth for short-range/local data transfer links, as well as cellular communications systems that can substantially extend its communicative range.

When interacting with the smartphone for a brief moment, it may be held in the hand and placed back down following use. However, there may be some situations in which the user is performing a primary task not with or relating to the smartphone, e.g., driving a vehicle, working on a computer, cooking, and so on, but would nevertheless desire to access a function or view something on the smartphone.

In response to these needs, various mounting devices have been developed. One configuration is a cradle that mechanically retains the smartphone, with the cradle being mounted to a structure. The compressive retention mechanisms are oftentimes cumbersome to engage and/or disengage, so more recently, magnetic mounts are being utilized. A mount head including one or more permanent magnets are fixed to the structure, with a metallic plate being attached to the rear of the smartphone. The magnets on the mount engage the metallic plate, thereby releasably engaging the smartphone to the mount. Whether utilizing a compressive or a magnetic retention, the mount is attached to a location within the interior of the vehicle that is visible and accessible by the driver and/or passengers. A variety of attachment modalities are known in the art, including suction cups and adhesives that secure the mount to a surface such as the windshield or the dashboard, adapters that fit within cupholders in the center console or within the compact disc player slot, as well as clips that attach to the louvers or grilles of air conditioning vents.

The use of air conditioning vents as a mounting location for mobile devices is relatively new, however, as vent mounts have been more common for air fresheners that are typically lighter in weight. The enclosed space of a vehicle interior tends to retain unpleasant odors from a variety of sources, and air fresheners may be utilized to adsorb, oxidize, sanitize, or mask the odorants. An inexpensive and widely used air freshener are the continuous action type, one example of which is a wick or reed impregnated with a volatile fluid with fragrance material. Such air fresheners may be hung from visors or placed in similar central locations within the interior of the vehicle.

Another continuous action type air freshener employs a gel material that incorporates the fragrance, and stored within a container, one surface of which is a semi-permeable material that allows the fragrance vapors to slowly disperse into the surrounding environment. These air fresheners may be mounted to the air conditioning vent, with either cooled or heated air further facilitating the dispersion of the fragrance vapors. Typical mounts utilized for such air fresheners had structural configurations matched to the relatively light weight thereof and were generally unsuitable for adaptation to heavier articles such as mobile devices. Several improvements to better retain and stabilize the mounts on the vent grilles/louvers that horizontally and vertically distribute load forces have been made.

There are a limited number of air conditioning vents in typical front dash on which various devices may be mounted. The driver seat is typically configured with left and right rear-facing vents, and the passenger seat is likewise configured with left and right rear-facing vents. Some vehicles may incorporate an additional central vent. The right driver-side vent is oftentimes partially obstructed by the steering wheel, so it is not an ideal location for a mobile device. Likewise, the left passenger-side vent is offset too much to the right and may also not be a practical location for mounting a mobile device. To optimize the circulation of fragrance in the vehicle, a centrally located air conditioning vent is preferable.

Accordingly, while there may be multiple air conditioning vents on which various devices can be mounted, the practical or usable mounting locations are more limited. Therefore, there is a need in the art for a consolidated air conditioning vent mount for mobile devices and air fresheners.

### BRIEF SUMMARY

The present disclosure contemplates a mount device that accepts a fragrance cartridge and incorporates a magnetic device mount head. In one embodiment, there may be a primary rotatable joint that has an extension stalk. Additionally, there may be a device mount head that is coupled to the primary rotatable joint. Furthermore, the mount device may include a mount stabilizer that defines central mount axis. The extension stalk may be fixed to the mount stabilizer in a coaxial relationship to the central mount axis. The mount device may include a cartridge cover that is defined by a front face. The cartridge cover may include a center bushing that extends from the front face. The center bushing may define a bore that is coaxial with the central mount axis of the mount stabilizer. The stalk of the primary rotatable joint may extend through the cartridge cover. The mount device may include a coupling that is attached to the mount stabilizer and the fragrance cartridge cover. The cartridge cover and the mount stabilizer may together define a cavity that is receptive to a fragrance cartridge defined by a cartridge body. This cartridge body may have a central opening and a slot extending from the central opening to an outer periphery of the cartridge body. The cartridge may also be receptive to the coupling.

Another embodiment of the present disclosure may be an apparatus for mounting to an air conditioning vent grille. The apparatus may include a circular housing that is defined by an open top end, a closed bottom end, a front face, and an opposed rear face. The circular housing may further define a cavity that is receptive to a circular fragrance cartridge. Such fragrance cartridge may have a main body that defines an engagement slot extending from a periphery to a central portion thereof. Additionally, the apparatus may include a mount stalk that is fixed to the central portion of the circular housing. The mount stalk may also be rotatably coupled to a device cradle. The mount stalk may be received within the engagement slot of the main body of the circular fragrance cartridge. The apparatus may further include a vent grill clamp that is fixed to and extends from the rear face of the circular housing.

Yet another embodiment of the present disclosure includes a vent mount. There may be a housing that defines an open top slot and an interior cavity that is receptive to a fragrance cartridge through the open top slot. The vent mount may also include a first rotatable joint element with an extension stalk that is centrally fixed to the housing. There may also be a magnetic device mount head with a second rotatable joint element that is coupled to the first rotatable joint element. The vent mount may further incorporate a vent grill clamp that is centrally fixed to and extends from the fragrance cartridge housing.

The present disclosure also contemplates another embodiment of a vent mount. There may be a housing that defines an open top slot and an interior cavity that is receptive to a fragrance cartridge through the open top slot. The vent mount may also include a first rotatable joint element with an extension stalk that is centrally fixed to the housing. The vent mount may have a lateral extension bar with a proximal end including a second rotatable joint element coupled to the first rotatable joint element and a distal end including a third rotatable joint element. There may also be a magnetic device mount head with a fourth rotatable joint element that is coupled to the third rotatable joint element on the distal end of the lateral extension bar. The vent mount may further incorporate a vent grill clamp that is centrally fixed to and extends from the fragrance cartridge housing.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front perspective view of a first embodiment of a magnetic device vent mount;

FIG. 2 is a partial exploded perspective view of the first embodiment of the magnetic device vent mount with the fragrance cartridge and the magnetic mount head separated from a cartridge housing;

FIG. 3 is a front plan view of the fragrance cartridge according to an embodiment;

FIG. 4 is a rear perspective view of a magnetic mount head;

FIG. 5 is an exploded perspective view of the magnetic device vent mount;

FIG. 6 is a rear perspective view of circular cover that is part of the first embodiment of the magnetic device vent mount;

FIG. 7 is a cross-sectional view of the first embodiment of the magnetic device vent mount;

FIG. 8 is a perspective view of a second embodiment of the magnetic device vent mount;

FIG. 9 is an exploded perspective view of the second embodiment of the magnetic device vent mount;

FIG. 10 is a cross-sectional view of the second embodiment of the magnetic device vent mount; and

FIG. 11 is a front perspective view of a variation of the magnetic device vent mount with an offset extension.

### DETAILED DESCRIPTION

The detailed description set forth below in connection with the appended drawings is intended as a description of the presently preferred embodiment of a magnetic device vent mount with a fragrance cartridge holder and is not intended to represent the only form in which it can be developed or utilized. The description sets forth the functions for developing and operating the mount in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, left, right, and the like are used solely to distinguish one from another element without necessarily requiring or implying any actual such relationship or order between such elements.

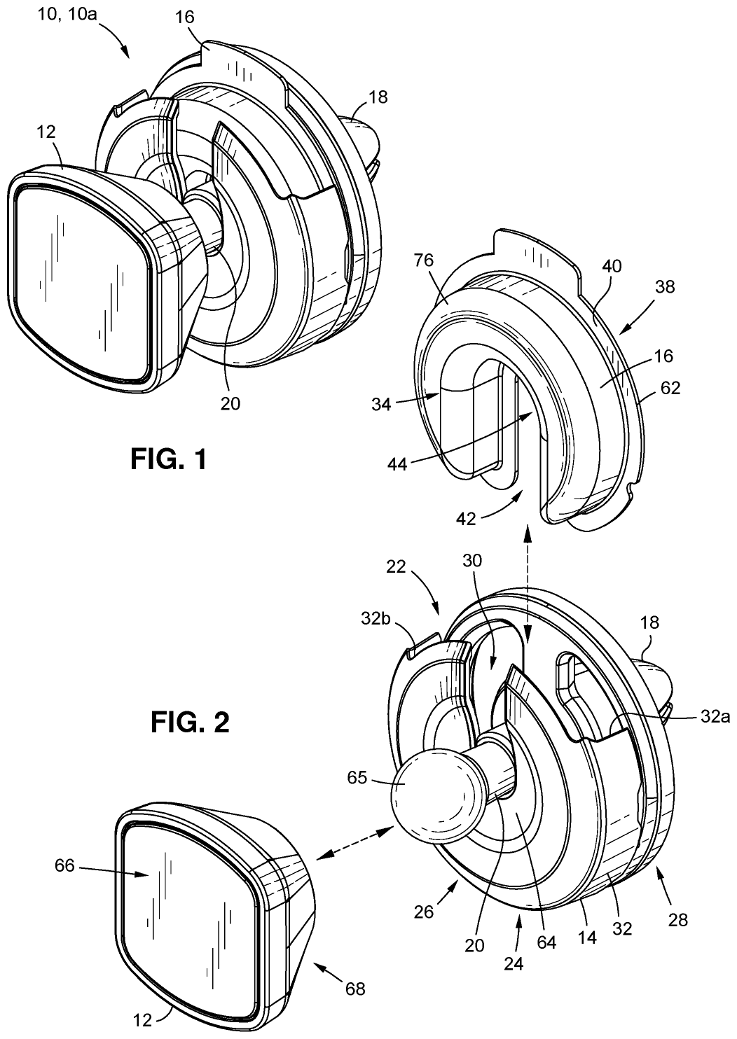

With reference to FIG. 1, a first embodiment of a mounting device 10a has a magnetic mount head 12, a cartridge housing 14 that accepts a fragrance cartridge 16, and a vent mount 18, each of which will be described in further detail below. It is generally contemplated that the magnetic mount head 12 engages with a corresponding metallic plate attached to, integral with, or otherwise coupled to an electronic device such as a cellular telephone, smartphone, phablet, tablet, and the like. The magnetic mount head 12 may be movably coupled to a stalk 20 that extends from the cartridge housing 14. The vent mount 18, in turn, is understood to be attachable to the louvers of a vehicle air conditioning vent to securely couple the magnetic mount head 12, an electronic device attached thereto, the cartridge housing 14, and the fragrance cartridge 16 received therein, to the air conditioning vent.

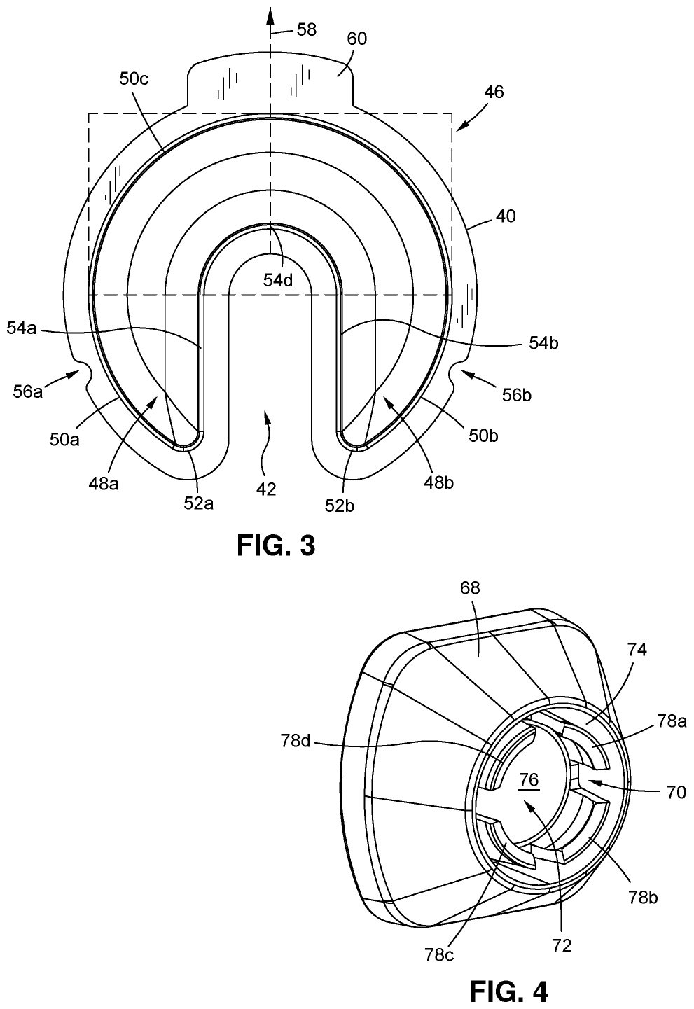

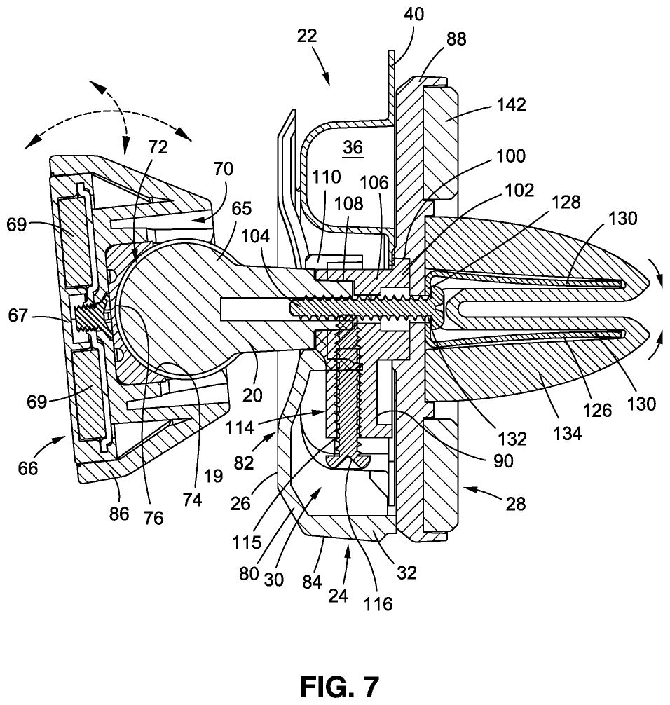

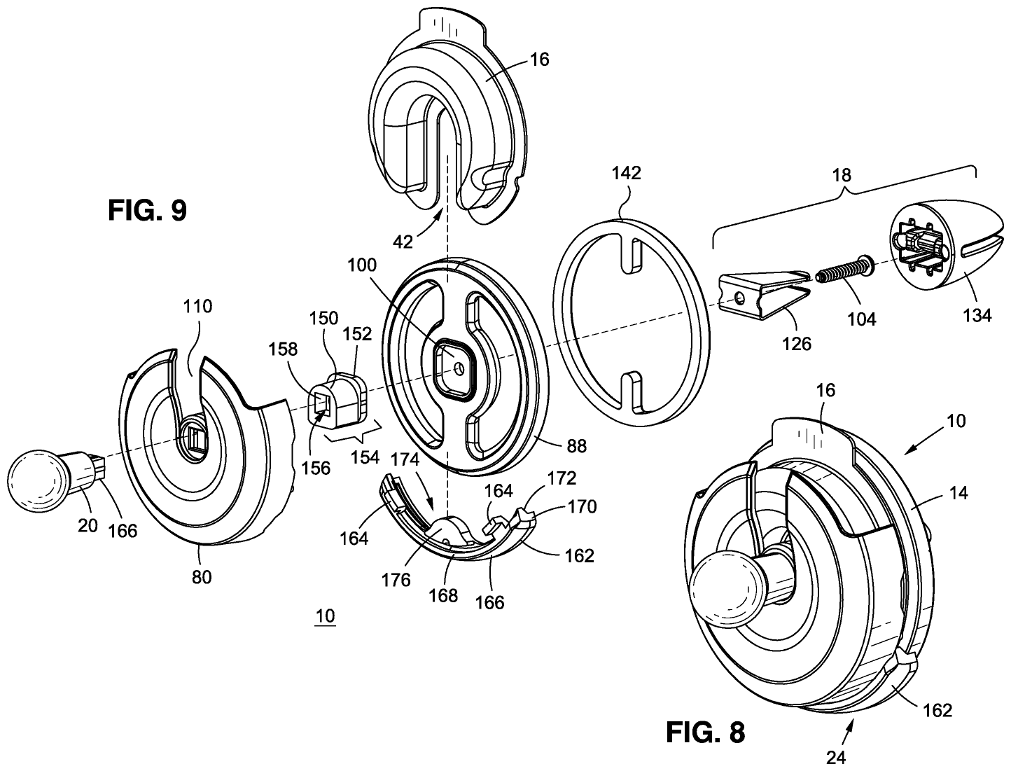

As shown in partially exploded perspective view of FIG. 2 as well as the cross-sectional view of FIG. 7, the cartridge housing 14 is defined by an open top end 22, a closed bottom end 24, a front face 26, and an opposed rear face 28. In the exemplary configuration, the cartridge housing 14 is circular, and therefore the front face 26 and the opposed rear face 28 have a circular shape. The cartridge housing 14 additionally defines an internal cavity 30 within which the fragrance cartridge 16 is received, and so the cartridge housing 14 has a circumferential sidewall 32 that terminates at lip extremities 32a, 32b of the open top end 22. The circular shape of the cartridge housing 14 is presented by way of example only and not of limitation, and any other suitable shape may be substituted. In this regard, the aforementioned features of the front face 26, the rear face 28, and the circumferential sidewall 32 thereof are likewise referenced in an exemplary sense only. To the extent the cartridge housing 14 has an alternative shape, alternative terms specific to such shapes are understood to be applicable.

Because the fragrance cartridge 16 is configured to be received within the cartridge housing 14, it is understood to have a shape that generally conforms to the internal cavity 30 thereof, e.g., circular. More specifically, the fragrance cartridge 16 may have a partially toroid geometry with a rounded front portion 34 that defines a body 36 of the fragrance cartridge 16, and a flat rear face 38 that is opposite the rounded front portion 34. There is also a flange rim 40 that is a part of the flat rear face 38.

With additional reference to FIG. 3, the body 36 of the fragrance cartridge 16, as well the flat rear face 38 that backs the body 36, has a U-shaped or horseshoe profile characterized by an engagement slot 42 that extends from the periphery to a central portion 44. In further detail, the body 36 is generally defined by a semicircular base section 46 with a left branch 48a and a right branch 48b integral therewith. The left branch 48a and the right branch 48b are curved inwardly toward each other, with a left outer sidewall 50a and a right outer sidewall 50b terminating at a left tip 52a and a right tip 52b, respectively. The outer sidewalls 50a, 50b are understood to be contiguous with an outer sidewall 50c of the semicircular base section 46.

The engagement slot 42 is defined at least partly by a left inner sidewall 54a extending from the left tip 52a, and a right inner sidewall 54b extending from the right tip 52b. In addition, the engagement slot 42 is partly defined by a central semicircular inner sidewall 54d that is contiguous with the left inner sidewall 54a and the right inner sidewall 54b. The central semicircular inner sidewall 54 generally corresponds to the central portion 44. The width of the engagement slot 42 may be varied, though as will be described in further detail below, in one embodiment it is slightly wider than the diameter of the stalk 20. The tips 52a, 52b may have a slight curvature to reduce any sharp edges that can snag within the internal cavity 30 of the cartridge housing 14.

The flange rim 40 extends outwardly from the entire outline of the body 36, and in a substantially perpendicular relationship to the respective inner and outer sidewalls 50, 54 described above. In this regard, the flange rim 40 may be structurally contiguous and/or have a uniform construction with the body 36. The edges of the flange rim 40 are understood to conform to the outline of the body 36 and thus have a uniform width, with a few exceptions.

One such exception is a pair of left and right notches 56a, 56b defined in the flange rim 40 of the respective left and right branches 48a, 48b of the body 36. As will be described in further detail below, the notches 56 are understood to frictionally engage with posts located within the internal cavity 30 so that the fragrance cartridge 16 remains within notwithstanding any minor vibration or jostling force typically encountered in a moving vehicle. In one exemplary embodiment, the notches 56 are circular with rounded edges. The flange rim 40 is understood to be constructed of a resilient plastic material that deforms in response to a certain degree of force applied thereto. Such force may be that which corresponds to a deliberate effort to manually remove the fragrance cartridge 16 from the cartridge housing 14, or to insert the fragrance cartridge 16 into the internal cavity 30. The specific positioning of the notches 56 relative to the center axis of the engagement slot 42, which in turn is the insertion and removal axis 58, is contemplated to facilitate such an removable engagement of the fragrance cartridge 16 and the cartridge housing 14.

Another exception is an upper tab 60 extending from that portion of the flange rim 40 corresponding to the semicircular base section 46. The upper tab 60 provides a surface by which t user can grasp the fragrance cartridge 16 in order to pull and remove the same from the cartridge housing 14. Along these lines, the upper tab 60 may be pushed and inserted into the internal cavity 30.

The body 36 of the fragrance cartridge 16 is understood to serve as the reservoir for a fluid material impregnated with a fragrance. To this end, the body 36 may be constructed of a resilient, non-permeable polymer material including polyethylene terephthalates (PET), polyethylene (PE), low-density polyethylene (LDPE), high density polyethylene (HDPE), polyvinyl chloride (PVC), polyamides or nylon, polyoxymethylene or Delrin, and so on. The body 36 may be transparent or translucent so that a user may immediately ascertain the volume of the fragrance fluid material that remains to decide that a replacement cartridge is necessary, and/or to distinguish one type of fragrance cartridge or another marked with different colorants. The fluid material may be a highly volatile liquid or oil. A variety of scents or fragrances that are either synthetically produced or naturally derived oils such as lavender, orange, lemon, vanilla, cedar, wood, sandalwood, and the like. Besides colorants and fragrances, the fluid material may incorporate other additives such as stabilizers, plasticizers, and/or lubricants. Furthermore, it is within the purview of one having ordinary skill in the art to select different fragrances, carrier fluids, colorants, and additives. There are numerous possible combinations and blends, and the present disclosure need not be limited to any particular one.

While the body 36 is not permeable, it is contemplated that the flat rear face 38 of the fragrance cartridge 16 may be. A thin, resilient though permeable film 62 may be affixed over the entirety of the fragrance cartridge reservoir and adhered to the flange rim 40. Glue, or any other suitable adhesive may be utilized to so affix the permeable film 62 to the body 36. The permeable film 62 is contemplated to slowly release the volatile fragrance material into the atmosphere. It will be appreciated that any suitable material may be utilized for the permeable film 62, and further, any other suitable fragrance or volatile liquid release modality may be substituted without departing from the scope of the present disclosure.

As indicated above, the cartridge housing 14 includes the stalk 20 extending from a central portion 64 thereof. The stalk 20 includes a ball joint 65 that is either integral with or fixedly attached to the end of the stalk 20 and is configured to be rotatably coupled to the magnetic mount head 12. In this regard, the ball joint 65 may also be referred to more generally as a primary rotatable joint. Although specific reference is made to the magnetic mount head 12, this is by way of example only and the ball joint 65 may be rotatably coupled to any other cradle-type apparatus that holds an electronic device, or any other attachment, including those with device charging functionalities, auto-clamping functionalities, and so on.

Referring again to FIG. 2 and the cross-sectional view of FIG. 7, the magnetic mount head 12 may be generally defined by a front face 66 and a head body 68. The front face 66 may be an elastomeric covering 67 that conceals a set of magnets 69 mounted to the head body 68, which in turn engages a ferromagnetic element. In one embodiment, this may be a standalone steel plate that is adhered to or otherwise attached to a mobile device or other object to be removably attached to the magnetic mount head 12.

With additional reference to FIG. 4, the rear of the head body 68 defines a pocket 70, within which there is a joint socket 72. The pocket 70 has an interior wall 74 and a circular floor 76. In the illustrated example, the joint socket 72 may be comprised of four socket tines 78a, 78b, 78c, and 78d that are circularly positioned around the pocket 70 in a spaced relationship to each other. The interior surfaces of the socket tines 78a-748 are each understood to have a partial spherical contour corresponding in size and shape to the ball joint 65 that is positioned within the joint socket 72. Along these lines, the tines 78 have an arcuate profile as part of such partial spherical contour.

Each of the tines 78 are understood to be slightly undersized relative to the size of the ball joint 65 so that it may be frictionally retained in a desirable orientation. The slight biasing force exerted in this configuration may be overcome by applying an axial force upon the ball joint 65/stalk 20. This is understood to spread apart the tines 78 to release the ball joint 65 from the grips of the joint socket 72. In this regard, the tines 78 are spaced away from the interior wall 74 to allow for such spreading. Though a ball-and-socket joint is shown, this is by way of example only and any other rotating/articulating engagement between the magnetic mount head 12 and the cartridge housing 14 are possible.

Stability at the endpoints of the mounting device 10, that is, the magnetic mount head 12 on one end, and the vent mount 18 at the opposite end, may be maximized by positioning each along the same axis, and attaching to a contiguous coaxial structure. More particularly, this structure extends through the cartridge housing 14 and intersects the internal cavity 30. The engagement slot 42 defined in the body 36 of the fragrance cartridge 16 provides a passageway for the structure thus configured. The vent mount 18 extends from the rear face 28 of the cartridge housing 14 in a direction opposite the magnetic mount head 12.

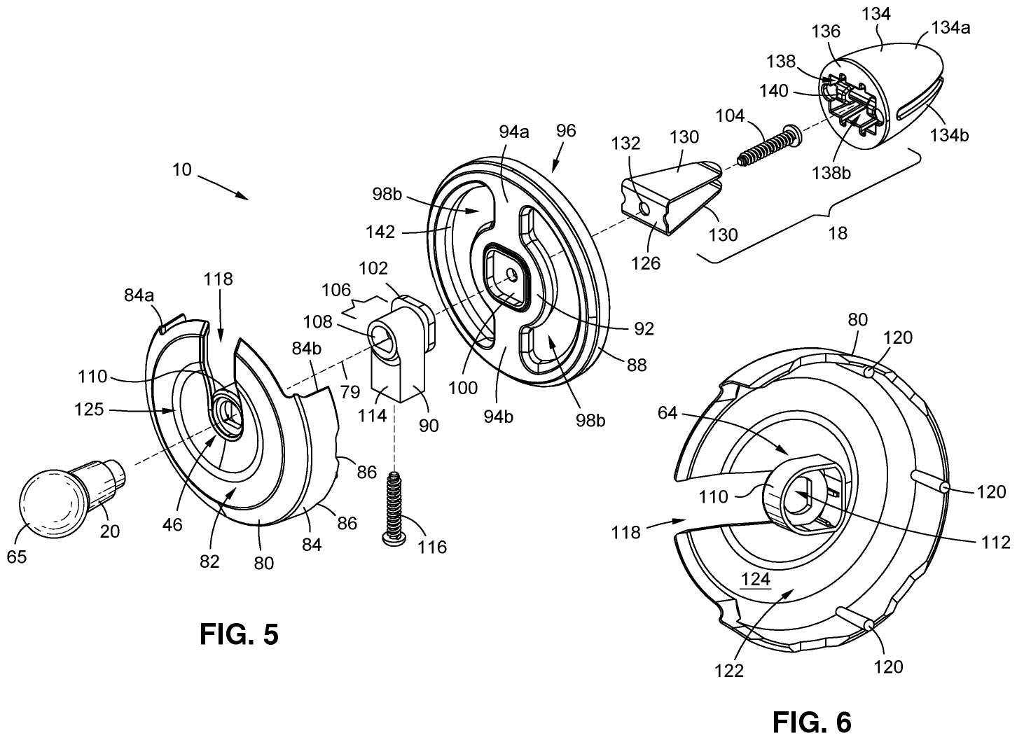

With reference to the exploded view of FIG. 5 as well as the cross-sectional view of FIG. 7, the cartridge housing 14 may be comprised of various subcomponents that are so positioned along a common central mount axis 79. Specifically, there may be a circular cover 80 with a cover face 82 that generally corresponds to the front face 26 referenced in the context of the overall cartridge housing 14. Additionally, there is a sidewall 84 that generally corresponds to the aforementioned circumferential sidewall 32 similarly referenced in the context of the overall cartridge housing 14. The sidewall 84 extends substantially around the circumference of the cover face 82, terminating at a left end 84a as well as an opposite right end 84b. Defined along the rim of the sidewall 84 are a series of venting indents 86 that permit the flow of air and fragrance material from the fragrance cartridge 16. The cartridge housing 14 may at least be a combined assembly of the circular cover 80 and a circular stabilizer 88 each attached to a coupling 90.

The circular stabilizer 88 is understood to have a circumference substantially corresponding to that of the circular cover 80, and defined by a central hub 92 integral with a pair of upper and lower spokes 94a, 94b extending to a peripheral circular rim 96. Within an interior region of the circular stabilizer 88, there are left and right hemispherical slots 98a, 98b. It is expressly contemplated that the hemispherical slots 98 open to the vehicle air conditioning vents, and exposes the permeable film 62 of the fragrance cartridge 16 to the airflow, aiding in the dispersion of the fragrance. The central hub 92 further defines a quadrangular recess 100 that receives a corresponding quadrangular flange 102 of the coupling 90. The quadrangular recess 100 and the quadrangular flange 102 may be sized and shaped for a friction fit. The center of the circular stabilizer 88 is aligned with the common central mount axis 79, and a fastener or screw 104 extends from the central hub 92 in alignment therewith.

The coupling 90 also includes a collar portion 106 abutting the quadrangular flange 102, and defines a keyed bore 108 that receptively engages the stalk 20. The axis of the keyed bore 108 is aligned and coaxial with the common central mount axis 79, and also receives the screw 104. The keyed bore 108 is so configured to prevent rotational movement of the stalk 20 when inserted therein according to one embodiment of the present disclosure.

In addition to being attached to the circular stabilizer 88, the coupling 90 is also attached to the circular cover 80. With additional reference to FIG. 6, there is an integral bushing 110 in the central portion 64 of the circular cover 80. The center axis of the bushing 110 is understood to be in axial alignment with the common central mount axis 79. The bushing 110 may further define a keyed opening 112 that has the same profile as the keyed bore 108 of the coupling 90 that is fitted within the bushing 110. The coupling 90 has an extension 114 from the collar portion 106, some sections of which are engaged to the bushing 110. In other embodiments, the coupling 90 and the bushing 110 may be a unitary structure. The extension 114 includes a passageway 115 through which a transverse fastener 116 may be inserted to secure the coupling 90 to the circular cover 80 and/or the stalk 20 when inserted through the keyed opening 112 and the keyed bore 108 of the coupling 90. The circular cover 80 additionally defines a cover slot 118 that extends from the outer periphery thereof to the central portion 64.

As mentioned above, the cartridge housing 14 incorporates various structural features that aid in aligning and retaining the fragrance cartridge 16 within its internal cavity 30. One such structural feature is the U-shaped fragrance cartridge 16 and the engagement slot 42, within which the coupling 90 and/or the stalk 20 is received. Although in some embodiments the stalk 20 does not extend entirely through the coupling 90, because the stalk 20 is fixed to the coupling 90, the stalk 20 may be considered as being received within the engagement slot 42 of the fragrance cartridge 16 because the coupling 90 may be an extension of the stalk 20. It is to be understood that while some features have been described as discrete components and subcomponents, different embodiments within the contemplation of the present disclosure may utilize different integrated combinations of features that form a unitary component or sub-component.

Another retention feature previously described is the series of notches 56 defined around the circumference of the flange rim 40 of the fragrance cartridge 16. As best shown in FIG. 6, the interior side of the circular cover 80 includes a series of circumferentially spaced posts 120 that extend the entire depth of the sidewall 32, and beyond. The notches 56 on the fragrance cartridge 16 are engageable to the posts 120 so that the fragrance cartridge 16 remains within the internal cavity 30.

An interior of the circular cover 80 may further define a circular protuberance 124 in a middle region 122 between the outer periphery and the central portion 64 thereof that is contemplated to provide an interference fit against the rounded front portion 34 of the fragrance cartridge 16. This circular protuberance 124 may be seen as a circular depression 125 on the cover face 82 of the circular cover 80. During insertion of the fragrance cartridge 16, the circular protuberance 124 partly inhibits such movement, but once fully inserted, the circular protuberance 124 is understood to clear the raised, rounded front portion 34 of the fragrance cartridge 16. This feature is likewise contemplated to aid in the retention of the fragrance cartridge 16.

The circular stabilizer 88, and hence cartridge housing 14 of which it is a part, includes the vent mount 18 that is configured to couple the mounting device to the louvers of an air conditioner vent. The vent mount 18 is comprised of a metallic clip 126 with a base 128 and a pair of opposed claws 130. There is a fastener hole 132 defined in the base 128. The screw 104 may be inserted through the fastener hole 132, and compress the base 128 against the circular stabilizer 88. The clip 126, and hence the vent mount 18, is understood to be in axial alignment with the common central mount axis 79.

The claws 130 may be received within an elastomeric jaw assembly 134 generally comprised of an upper jaw 134a and a lower jaw 134b, with a common base 136. In the illustrated example, the jaws 134 are vertically offset from each other, and define a horizontally oriented separate between which a horizontal vent louver is retained. Each of the upper and lower jaws 134a, 134b define respective cavities 138a, 138b that are receptive to the corresponding claws 130 of the metallic clip 126. The upper jaw 134a and the lower jaw 134b, like the claws 130 inserted therein, are configured to be movable relative to each other, and so there may be a joint structure 140 within the common base 136. The claws 130 are biased toward each other, such that they exert a compressive force against the upper jaw 134a and the lower jaw 134b. The jaws 134 may be spread apart manually to provide clearance for the vent louvers while the mounting device 10 is being attached thereto. Alternatively, the open end of the jaws 134 may be pressed on to the vent louvers and inserted further therein. Once fully attached on to the louvers, the jaws 134, and the claws 130, are understood to be compressively retained thereon.

In addition to defining a part of the cartridge housing 14, the circular stabilizer 88 is contemplated to minimize rotational movement about transverse axes normal to the common central mount axis 79. The peripheral circular rim 96 and interior portions of the circular stabilizer 88 may be abutted against the air conditioning vent louver and prevent from further rotation. To provide further frictional engagement to the vent louver, the rear side of the circular stabilizer 88 may include an elastomeric pad 142 that extends around the circumference of the circular stabilizer 88.

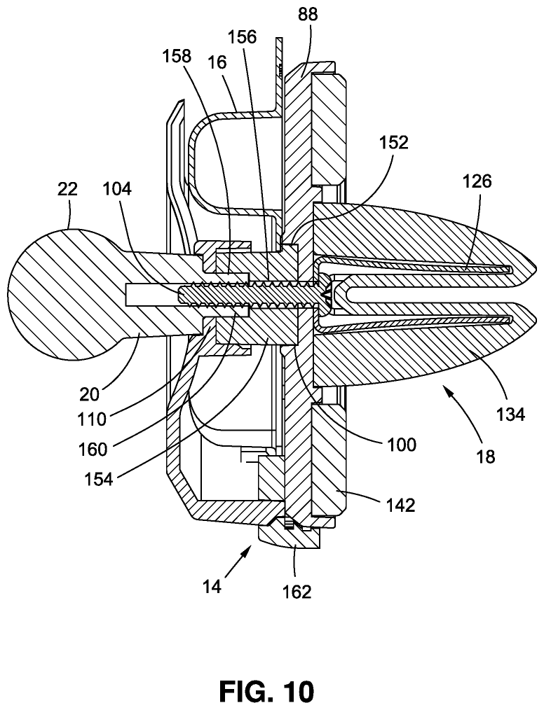

FIGS. 8, 9 and 10 depict a second embodiment of the magnetic mounting device 10b that accepts the fragrance cartridge 16 within its housing 14. Many of the same components utilized in the first embodiment 10a described above are also utilized in the second embodiment 10b, including the vent mount 18 comprised of the same metallic clip 126 and elastomeric jaw assembly 134. The metallic clip 126 is attached to the same circular stabilizer 88 with the screw 104. Additionally attached to the rear of the circular stabilizer 88 is the elastomeric pad 142. The housing 14 likewise includes the circular cover 80 with the bushing 110, to which the stalk 20 is coupled. The screw 104 extends through the stabilizer 88, an alternatively configured coupling 150, and partly through the bushing 110/circular cover 80. The screw 104 is threaded and secured onto the stalk 20, which accepts the magnetic mount head 12.

The coupling 150 similarly includes a quadrangular flange 152 received within the quadrangular recess 100 defined by the circular stabilizer 88. The coupling 150 is also defined by a collar portion 154, with a through bore 156 extending through the collar portion 154. The through bore 156 is stepped, and there is a wider counterbore 158 that is sized and shaped to accept a quadrangular key 160 at the tip of the stalk 20. The collar portion 154 is received within a circular opening of the bushing 110.

The closed bottom end 24 of the housing 14 further includes a drip catch 162 that attaches to the circular cover 80 with clips 164. The drip catch 162 has partially circular catch body 166 with a front rim 168 and an opposed rear rim 170. Additionally, there is a tapered inner rim 172 that conforms to the outer contour of the stabilizer 88. In a central region 174 of the catch body 166, there is a protuberance 176 that roughly conforms to the width of the engagement slot 42 of the fragrance cartridge 16. The protuberance 186 is understood to frictionally retain, or at least position or align the fragrance cartridge 16 within the housing 14, and prevent lateral movement of the same.

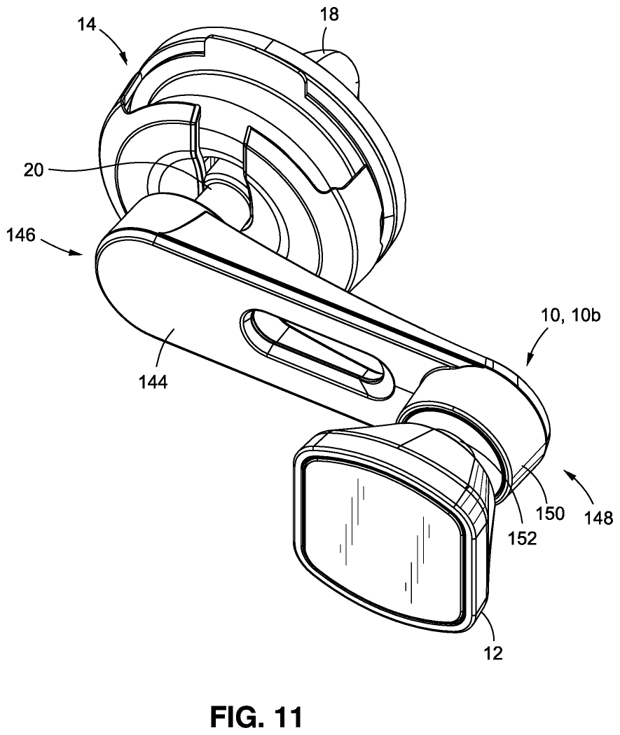

Referring again to FIG. 1, the embodiment of the mounting device 10a shown therein contemplates a direct coupling of the magnetic mount head 12 to the stalk 20. That is, the magnetic mount head 12, the stalk 20, the cartridge housing 14, and the vent mount 18 are arranged along the single common central mount axis 79. As shown in FIG. 11, an offset extension bar 144 may be rotatably coupled to the stalk 20 and the ball joint 65 fixed thereto. More specifically, the offset extension bar 144 may be defined by a first or proximal end 146 that includes the same joint socket as those described above in relation to the magnetic mount head 12. Such joint socket, in turn, may be rotatably coupled to the stalk 20. The offset extension bar 144 may also be defined by a second or distal end 148. This distal end 148 may include a joint base portion 150 to which a second stalk 152 is attached. At the end of the second stalk 152 may be another ball joint, which rotatably couples to the magnetic mount head 12. In all respects, this magnetic mount head 12 is the same as that which was described above in the context of the first embodiment 10a, so details thereof will be omitted. Because the offset extension bar 144 is rotatable relative to the stalk 20, it may be extended to the left, to the right, to the bottom, to the top, or anywhere in between to better position and orient the magnetic mount head 12.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A mounting device, comprising:
a primary rotatable joint with an extension stalk;
a device mount head coupled to the primary rotatable joint;
a mount stabilizer defining a central mount axis, the extension stalk being fixed to the mount stabilizer in a coaxial relationship to the central mount axis;
a cartridge cover defined by a front face and including a center bushing extending from the front face, the center bushing defining a bore coaxial with the central mount axis of the mount stabilizer, the stalk of the primary rotatable joint extending through the cartridge cover; and
a coupling attached to the mount stabilizer and the fragrance cartridge cover, the cartridge cover and the mount stabilizer together defining a cavity receptive to a fragrance cartridge defined by a cartridge body with a central opening and a slot extending from the central opening to an outer periphery of the cartridge body, and receptive to the coupling.

2. The mounting device of claim 1, wherein the device mount head is directly coupled to the primary rotatable joint.

3. The mounting device of claim 1, further comprising an extension bar having a first end directly coupled to the primary rotatable joint and an opposed second end directly coupled to the device mount head.

4. The mounting device of claim 1, further comprising a vent clamp attached to the mount stabilizer, the vent clamp including a plurality of clamp jaws.

5. The mounting device of claim 4, wherein a pair set of the plurality of clamp jaws are vertically offset from each other and defining a horizontally oriented separation between which a horizontal vent louvre is retained.

6. The mounting device of claim 5, further comprising a biasing clip embedded within the pair set of the plurality of clamp jaws.

7. The mounting device of claim 1, wherein the mount stabilizer defines one or more apertures open to the cavity defined between the mount stabilizer and the cartridge cover.

8. The mounting device of claim 1, wherein the cartridge cover defines a partial peripheral wall extending from the perimeter of the front face.

9. The mounting device of claim 1, further comprising an elastomeric pad attached to the mount stabilizer at a side opposite that which defines a part of the cavity.

10. The mounting device of claim 1, wherein the front face of the cartridge cover further defining a cover slot extending from an outer periphery thereof to the center bushing.

11. An apparatus for mounting to an air conditioning vent grille, comprising:
a circular housing defined by an open top end, a closed bottom end, a front face, and an opposed rear face, the circular housing further defining a cavity receptive to a circular fragrance cartridge with a main body defining an engagement slot extending from a periphery to a central portion thereof;
a mount stalk fixed to the central portion of the circular housing and rotatably coupled to a device cradle, the mount stalk being received within the engagement slot of the main body of the circular fragrance cartridge; and
a vent grill clamp fixed to and extending from the rear face of the circular housing.

12. The apparatus of claim 11, wherein the circular housing defines a vertical slot extending from a periphery of an open top end portion of the front face to a central bushing.

13. The apparatus of claim 11, wherein the mount stalk includes a ball joint that is rotatably coupled to a magnetic device mount head with a corresponding socket receptive to the ball joint.

14. The apparatus of claim 11, wherein the rear face of the circular housing defines a a pair of semicircular apertures opening to the cavity.

15. The apparatus of claim 11, wherein the circular housing defines a series of vents around a circumference thereof.

16. The apparatus of claim 11, further comprising an elastomeric pad attached to the rear face of the circular housing, the elastomeric pad extending around a circumference of the rear face of the circular housing.

17. The apparatus of claim 11, wherein the device cradle is directly coupled to the mount stalk.

18. The apparatus of claim 11, further comprising an extension bar having a first end directly coupled to the mount stalk and an opposed second end directly coupled to the device cradle.

19. A vent mount, comprising:
a housing defining an open top slot and an interior cavity receptive to a fragrance cartridge through the open top slot;
a first rotatable joint element with an extension stalk centrally fixed to the housing;
a magnetic device mount head with a second rotatable joint element coupled to the first rotatable joint element; and
a vent grill clamp centrally fixed to and extending from the fragrance cartridge housing.

20. The vent mount of claim 19, wherein the housing defines a front and rear, the extension stalk being attached to the front and the rear through the housing.

21. A vent mount, comprising:
a housing defining an open top slot and an interior cavity receptive to a fragrance cartridge through the open top slot;
a first rotatable joint element with an extension stalk centrally fixed to the housing;
a lateral extension bar with a proximal end including a second rotatable joint element coupled to the first rotatable joint element and a distal end including a third rotatable joint element;
a magnetic device mount head with a fourth rotatable joint element coupled to the third rotatable joint element on the distal end of the lateral extension bar; and
a vent grill clamp centrally fixed to and extending from the fragrance cartridge housing.

22. The vent mount of claim 21, wherein the housing defines a front and rear, the extension stalk being attached to the front and the rear through the housing.
